(19) United States
(12) Patent Application Publication
(10) Pub. No.: US 2023/0231414 A1
(43) Pub. Date: Jul. 20, 2023

(54) Magnetic Resonance Wireless Charging System for a Vehicle

(71) Applicant: Motherson Innovations Company Limited, London (GB)

(72) Inventors: Abdon E. Saenz de Viteri, Farmington Hills, MI (US); Kerstin Gerdes, Farmington Hills, MI (US)

(21) Appl. No.: 18/002,497

(22) PCT Filed: Jun. 28, 2021
(86) PCT No.: PCT/EP2021/067708

§ 371 Date: Dec. 20, 2022

Related U.S. Application Data
(60) Provisional application No. 63/044,382, filed on Jun. 26, 2020.

(51) Int. Cl. H02J 50/00; H02J 50/20; H02J 50/40; B60R 16/02

(52) U.S. Cl. CPC H02J 50/005; H02J 50/20; H02J 50/402; B60R 16/02

(57) ABSTRACT

A wireless charging system may comprise a center console affixed in a vehicle. A layer assembly is attached to the center console. The layer assembly comprises a printed circuit board (PCB) that contains at least one amplifier, at least one filter, and at least one transmitting antenna. A power source is connected to the PCB and is activated at vehicle start or with the activation of a switch. The at least one transmitting antenna is oriented within 0 mm to 25.4 mm from an outer surface of the center console. The transmitting antenna produces a charging zone that emits power within an area that has a shape approximately equaling a cone and provides up to 25 watts of power to a mobile device that comprises a receiving antenna. The mobile device may be a cell phone, a wearable, a dongle, a wireless earbud, or a tablet.

### CROSS-REFERENCE TO RELATED APPLICATIONS

This application is a National-Stage Entry of International Patent Application No. PCT/EP2021/067708 filed on Jun. 28, 2021, which claims to U.S. Provisional Patent Application No. 63/044,382 filed on Jun. 26, 2020, each of which is incorporated by reference in its entirety for all purposes.

### BACKGROUND

### 1. Field

The present disclosure relates generally to wireless charging of batteries by magnetic resonance, including batteries in mobile computing devices in a vehicle. In particular it refers to a wireless charging system mounted to a vehicle, a vehicle component with such a wireless charging system and a vehicle with such a vehicle component.

### 2. Related Art

Mobile devices are commonly brought into vehicles by drivers and passengers. It is desirable for a vehicles, such as passenger cars, vans and trucks, to include battery charging options for mobile devices. Wireless charging in vehicles is known to reduce issues with having charging wires plugged in at inconvenient locations or becoming an entanglement hazard during the operation of a vehicle. Current wireless charging solutions include the use of a flat charging pad located in the center console of the vehicle. The flat charging pads requires the mobile computing device to be aligned for charging in the correct position and in contact with or within a very small distance of the charging pad. Without a correct alignment and a correct contact distance, wireless charging of the mobile computing device will not occur. Flat wireless pad charging solutions also require dedicated space in the vehicle systems such as the center console and do not allow for flexibility of placement in the vehicle.

Current wireless charging solutions only allow for a single mobile device to be charged at a time. There could, potentially, be many mobile devices brought into a vehicle which may need power charging. The ability to only charge a single mobile device at a time creates a bottleneck for obtaining power for charging of mobile devices.

Wireless charging can occur through magnetic resonance technology. The magnetic resonance works over an antenna creating an electromagnetic field that will produce the emission of electric power to a device with a specific receiver for that electromagnetic field. The magnetic resonance technology does not need a mobile device to touch a surface to charge as would be required for a Qi-pad charging system. The mobile device may receive power up to a distance of eighteen inches away from the antenna but the strength of the wireless charging will depend on distance and obstacles between a transmitting antenna and a receiver in a mobile device.

A recharging charging panel unit installed at a front portion of a center fascia in a vehicle and having a bottom portion on the upper surface of which a wireless power receiver can be placed, is known from KR101145682B1.

### SUMMARY

It is the object of this disclosure to provide to a wireless charging system mounted to a vehicle, a vehicle component with such a wireless charging system and a vehicle with such a vehicle component overcoming the drawbacks of the prior art. In particular a magnetic resonance wireless charging solution for mobile devices in a vehicle is to be provided that overcomes at least some of the stated problems above.

This object is achieved by a wireless charging system of claim 1, with specific aspects thereof being described in claims 2 to 12.

A wireless charging system for a center console in a vehicle. A layer assembly is attached to the center console. The layer assembly comprises a printed circuit board (PCB) that contains at least one amplifier, at least one filter, and at least one transmitting antenna. A power source is connected to the PCB and is activated at vehicle start or with the activation of a switch. The at least one transmitting antenna is oriented within 0 mm to 25.4 mm from an outer surface of the center console. The transmitting antenna produces a charging zone that emits power within an area that has a shape approximately equaling a cone and provides up to 25 watts of power to a mobile device that comprises a receiving antenna. The mobile device may be a cell phone, a wearable, a dongle, a wireless earbud, or a tablet. The dongle may be electrically connected to at least one of an LED, a seat motor, a window motor, a door locking mechanism, or a sensor.

It should be noted that the features set out individually in the following description may be combined with each other in any technically advantageous manner and set out other forms of the present disclosure. The description further characterizes and specifies the present disclosure in particular in connection with the Figures.

### BRIEF DESCRIPTION OF THE DRAWINGS

In order that the disclosure may be well understood, there will now be described various forms thereof, given by way of example, reference being made to the accompanying drawings, in which:

FIG. 1 is a perspective view of a center console for a vehicle according to the present disclosure;

FIG. 2 is a top view of the center console according to the present disclosure;

FIG. 3 illustrates the layers of the wireless charging system in the center console according to the present disclosure;

FIG. 4 is a side view of the center console wireless system according to the present disclosure;

FIG. 5 illustrates the wireless charging according to the present disclosure;

FIG. 6 is a side view of the center console wireless system illustrating an example charging zone according to the present disclosure;

FIG. 7 is a side view of the center console wireless system illustrating a second example charging zone according to the present disclosure; and

FIG. 8 is a rear perspective view of a vehicle interior according to the present disclosure.

### DETAILED DESCRIPTION

The following description is merely exemplary in nature and is not intended to limit the present disclosure, application, or uses. It should be understood that throughout the drawings, corresponding reference numerals indicate like or corresponding parts and features.

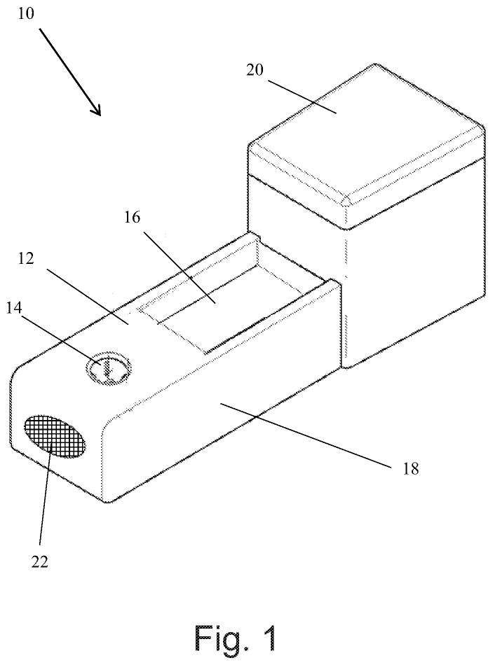

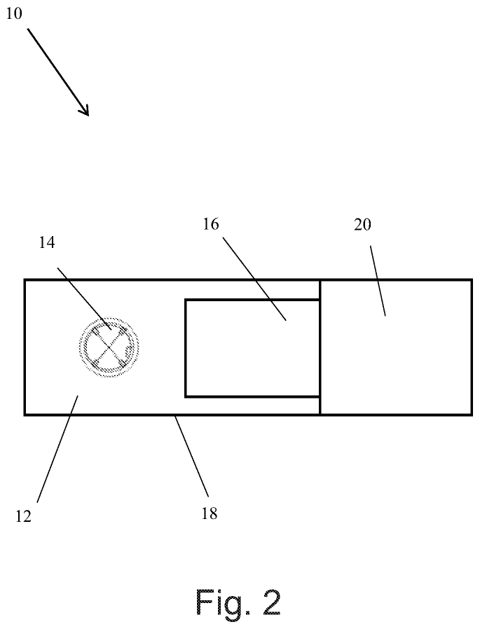

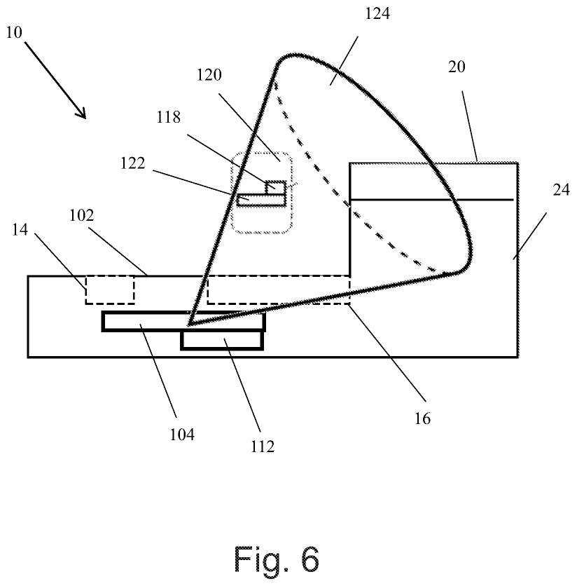

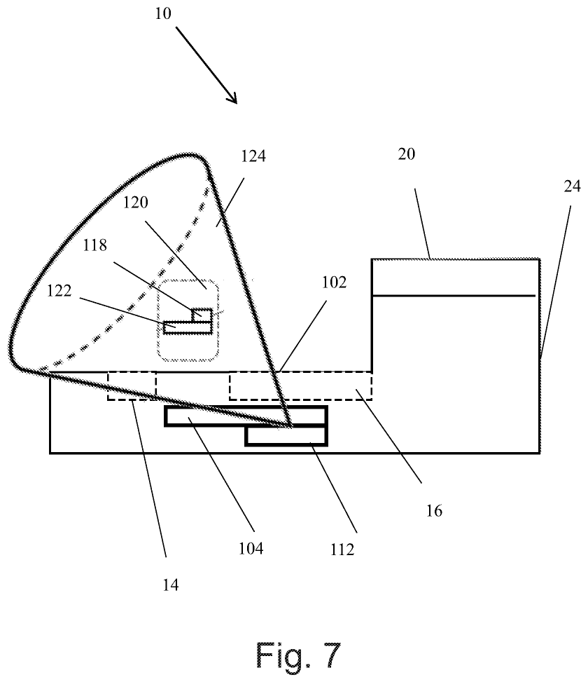

FIGS. 1-2 illustrate a center console 10 in a vehicle. The center console 10 may contain elements such as an armrest 12, at least one cup holder 14, a storage shelf 16, a panel 18, a storage compartment 20, or an air duct 22. The center console 10 with any of the above components may be used for housing a wireless charging system or for providing a location for placing the mobile device 120, FIG. 6 or 7.

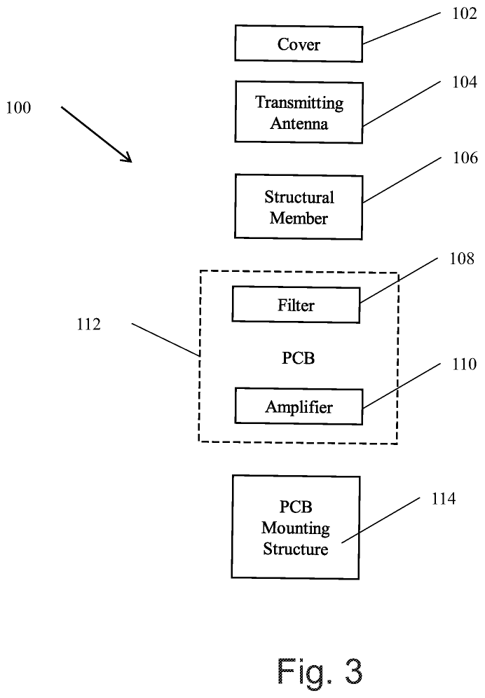

FIG. 3 illustrates a layer assembly 100 for use as a wireless charging system. The layer assembly 100 has a printed circuit board PCB mounting structure 114 as a base layer to support and attach a printed circuit board PCB 112. The PCB mounting structure 114 may be designed to be over molded into the center console 10 or designed to be fastened within the center console 10 with any known fastening system such as screws, or adhesive as non-limiting examples. The PCB 112 is attached to the PCB mounting structure 114. In this form, the PCB 112 contains at least one filter 108 and at least one amplifier 110. The number of filters 108 and amplifiers 110 on the PCB 112 is dependent upon the power requirements of the system. The next layer in the layer assembly 100, in this form, is a structural member 106. The structural member 106 may be an integral part of the center console 10 or a separate part for attaching at least one transmitting antenna 104. A structural member 106 is made from a non-metal material and may be optional depending on the design of the center console.

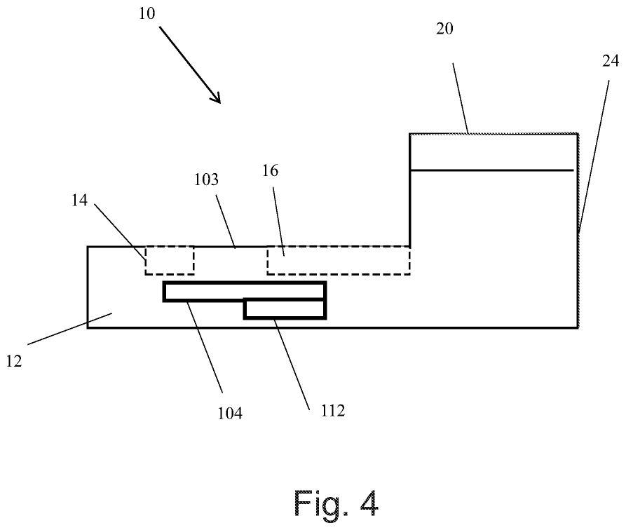

The at least one transmitting antenna 104 is placed in the layer assembly 100 within the center console 10. One exemplary placement location for the at least one transmitting antenna 104 is shown in FIG. 4. The at least one transmitting antenna 104 may be mounted on the structural member 106 if present or over molded directly into the center console 10. The at least one transmitting antenna 104 may also be mechanically attached to the center console 10 by any known fastening system. The number of transmitting antennas 104 and the size of the at least one transmitting antenna 104 is determined by wireless charging power system parameters. The at least one transmitting antenna 104 may be tubular in shape and may be a circular or square cross-section containing a cylinder with coiled copper element around the cross-section dimension of the cylinder. The coiled copper element allows for power level tuning from milliamps to kilowatts. The at least one transmitting antenna 104 operates at a desired frequency around 6.78 MHz. The exemplary layer assembly is shown with a cover 102. The cover 102 is utilized to protect the at least one transmitting antenna 104. The cover 102 may be optional if the transmitting antenna 104 is manufactured by over molding in the center console 10.

FIG. 4 illustrates an exemplary placement of the at least one transmitting antenna 104 and PCB 112. In this exemplary, placement the at least one transmitting antenna 104 and the PCB 112 is illustrated in FIG. 4 without the PCB mounting structure 114, the structural member 106, and the cover 102 for clarity. In this form, the at least one transmitting antenna 104 is designed to be placed between a bulkhead 24 and the at least one cup holder 14. In other variations the at least one transmitting antenna 104 may be placed in various regions of the center counsel, including outside of the region between the at least one cup holder 14 and the bulkhead 24. The at least one transmitting antenna 104 is placed at an operating distance, preferably at least 2 cm, from any metal devices or metal elements which may be part of the center console 10. Metal devices and metallic elements will create an interference with the at least one transmitting antenna 104 and affect the performance of the wireless charging system. The at least one transmitting antenna 104 must also be placed within an operating distance from an outer surface 103 preferably between 0 mm and 25.4 mm. In other variations the operating distance may exceed 25.4 mm. This distance ensures the wireless power will exit the center console 10 and provide wireless power to the mobile device 120, as seen in FIG. 6. In this form, the outer surface 103 acts as the cover 102. In other variations, the center console 10 may contain a separate cover 102 below the outer surface 103, particularly if the transmitting antenna 104 and PCB 112 is molded or bolted into the center console 10. The at least one transmitting antenna 104 and the PCB 112 may also be located within or around the air duct 22, as seen in FIG. 1. The at least one transmitting antenna 104 may be placed within the area of the air duct 22 to transmit power through the polymeric parts of a center console 10 up to 45.7 cm (eighteen inches) away. This would allow the mobile device 120 held by a driver or passenger of the vehicle to receive wireless power to charge the mobile device 120.

In another placement variation, the at least one transmitting antenna 104 and the PCB 112 may also be installed into the storage compartment 20. The at least one transmitting antenna 104 may be installed in the lid of a storage compartment 20, below the bottom segment of any storage unit or around the structure of a storage compartment. In this form, the PCB 112 would be installed below the at least one transmitting antenna 104 or on the side of the storage compartment 20. The at least one amplifier 110 and the at least one filter 108 of the PCB 112 may also be placed below the structural part of an armrest 12 or on the bottom of a storage compartment (not shown) located under the armrest.

The PCB 112 and the at least one transmitting antenna 104 could be designed in a different arrangement and is not limited to the illustrated arrangement shown in FIG. 4. It is within the scope of this disclosure to locate the placement of the at least one transmitting antenna 104 and the PCB 112 near or in any of the components of the center console 10 describe in FIGS. 1 and 2.

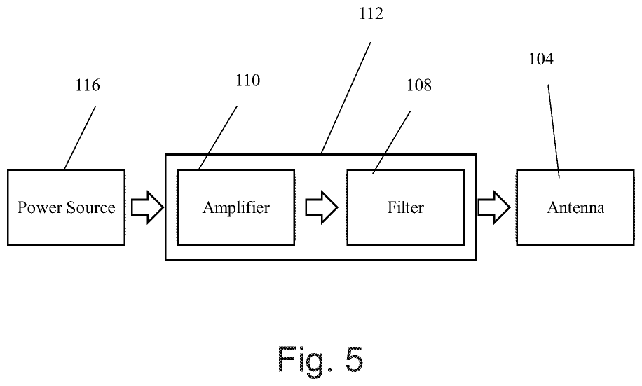

FIG. 5 represents an illustration of the power flow through the wireless charging system. The power source 116 provides power to the wireless charging system. The power source 116 is connected to the vehicle electrical systems to provide power and may be directly connected by a wire or indirectly connected by a connector to the vehicle electrical power system or a DC power source. The power source 116 is activated at vehicle start, with the activation of a switch/button, or with any human machine interface (HMI) allowing a user to initiate wireless charging capability. The activation of the wireless charging system may be indicated with the use of a lighting element, not shown. This lighting element may be provided as a backlighting arrangement or as a single LED. The power source 116 provides power to the PCB 112 containing the at least one amplifier 110 and the at least one filter 108. Power also flows to the transmitting antenna 104 which provides the wireless charging to a mobile device 120, best seen in FIG. 6.

FIG. 6 illustrates a side view of the center console 10 with the wireless power charging system energized. The at least one transmitting antenna 104 creates a charging zone 124. The charging zone 124, in this form, uses magnetic resonance to emit a field within an area that has a shape approximately equaling a cone. The charging zone 124 is shown to extend from the at least one transmitting antenna 104 and project through the storage shelf 16 and the storage compartment 20. In one form the charging zone 124 can extend to 25.4 cm (10 inches) from the transmitting antenna 104. In other variations the charging zone 124 may extend further than 10 inches from the transmitting antenna 104 or be less than 10 inches. The size and shape of the charging zone 124 is dependent on the position, orientation and number of the at least one transmitting antenna 104. In other forms, multiple transmitting antennas 104 may be used to create multi-dimensional charging areas in proximity to the center console 10. Alternatively, the power to the transmitting antenna 104 may be amplified to create a multi-dimensional field, or a wider field. In either form, multiple devices are able to be charged simultaneously within the charging zone 124. The mobile device 120 has a receiving antenna 122 capable of receiving power from a wireless charging source and a receiving PCB 118 which includes a rectifier. When the receiving antenna 122 is placed within the charging zone 124, the mobile device 120 will receive power from the at least one transmitting antenna 104 and be charged. The placement of the receiving antenna 122 within the charging zone 124 and the distance from the at least one transmitting antenna 104 determines the charging capability. If the receiving antenna 122 is placed closer to the at least one transmitting antenna 104, the charging will be higher than at outside edges of the charging zone 124. The distance the receiving antenna 122 can be from the at least one transmitting antenna 104 is between zero to 63.5 cm (twenty five inches).

More than one mobile device 120 may be charged within the charging zone 124 at the same time. If more than one mobile device 120 is placed within the charging zone 124, the wireless charging power will be split between the devices. This power split reduces the power received for charging to each mobile device 120. The mobile device 120 could be any mobile electric device capable of receiving wireless charging. Non-limiting examples of a mobile device 120 are a personal cell phone, a tablet, a wireless earbud, a wearable device, or a dongle system.

The dongle as a mobile device 120, may be used in the vehicle to provide lighting or other electric functions of the vehicle. One form of a wireless charging system with the dongle is to use a dongle directly connected to an LED in the center console 10. The dongle would be placed within the charging zone 124 and receive power when the LED is switched on and the charging zone 124 is active. The use of the dongle would reduce the need to have a dedicated wiring connection between the LED and the vehicle. The dongle use in the wireless charging system could be adapted for charging other electric vehicle functions such as a seat motor, a window motor, a door locking mechanism, mirror motor, lighting mechanisms within the vehicle, sensors, or other similar devices if the dongle is placed within the charging zone 124. Additionally, the dongle may be integrated within any interior device component.

FIG. 7 illustrates another form of the charging zone 124. The charging zone 124 is oriented to provide charging to a mobile device 120 placed in the at least one cup holder 14 area or the storage shelf 16. For example, one mobile device 120 placed in the at least one cup holder 14 may receive ten to fifteen watts of wireless charging. The same mobile device 120 placed on the storage shelf 16 could receive twenty watts of power from the at least one transmitting antenna 104. The wireless charging system may provide over 25 watts of power dependent on design considerations. The wireless charging of the mobile device 120 occurs regardless of the orientation of the mobile device 120 if the receiving antenna 122 is within the charging zone 124. If the mobile device 120 is outside the charging zone 124, it will receive 0 watts from the wireless charging system.

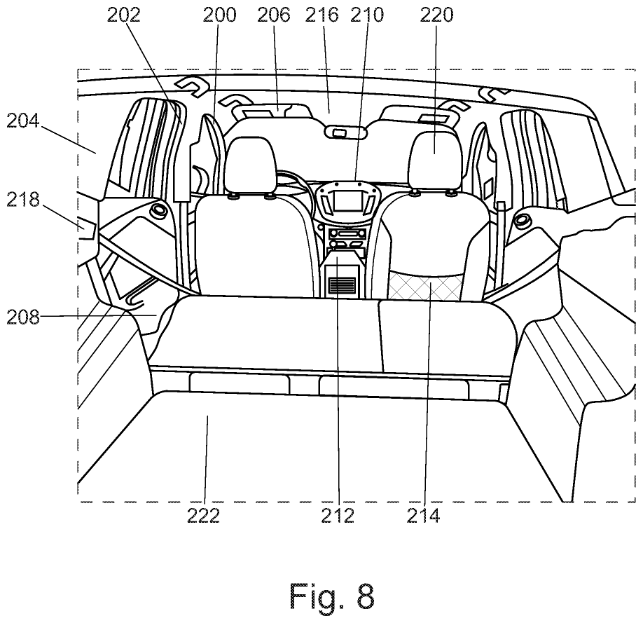

FIG. 8 illustrates a rear interior view of the vehicle. The wireless charging system described in this disclosure may be integrated in other areas of the vehicle in a similar implementation to the center console 10 describe above. Non-limiting examples of other similar implementations would be in an A-pillar 200, a B-pillar 202, a C-pillar 204, a sun visor 206, a door panel 208, an instrument panel 210, an armrest 212, a seat 214, a headliner 216, a seat belt housing 218, a headrest 220, and/or a rear storage compartment 222. Other implementations may include the wireless charging integrated into a rearview or side mirror assembly. The wireless charging system may be used to provide power to the mirrors to activate actuation elements, lighting elements, or heating elements within the mirror assembly. Alternatively, the wireless charging system may be incorporated within a roof assembly, preferably a convertible roof assembly, so as to provide power for dome lights, moon roofs, roof actuators, and similar roof accessories.

The wireless charging system may also be incorporated into a textile surface of the any of the above vehicle locations. In this form, the cylinder portion of the transmitting antenna 104 may be woven into a textile surface and attached to the transmitting antenna 104 and the PCB 112. This form may be used in locations such as a map pocket or the headliner to provide wireless charging power.

In another variation, the wireless power system may also be mounted within a center console 10 to provide power to a cooling or heating device that has a corresponding receiving antenna 122. In order to function effectively in this variation the transmitting antenna 104 would need to be in close proximity to the charging zone 124 to supply the correct power charging to the receiving antenna 122.

The foregoing description of various preferred embodiments have been presented for purposes of illustration and description. It is not intended to be exhaustive or to limit the disclosure to the precise forms disclosed, and obviously many modifications and variations are possible in light of the above teaching. The example embodiments, as described above, were chosen and described in order to best explain the principles of the disclosure and its practical application to thereby enable others skilled in the art to best utilize the disclosure in various embodiments and with various modifications as are suited to the particular use contemplated. The features disclosed in the foregoing description, in the drawings and in the claims can be essential both individually and in any combination for the implementation of this disclosure in its various embodiments.

### REFERENCE SIGN LIST

10 Center Console
12 Armrest
14 Cup Holder
16 Storage Shelf
18 Panel
20 Storage Compartment
22 Air Duct
24 Bulkhead
100 Layer Assembly
102 Cover
103 Outer Surface
104 Transmitting Antenna
106 Structural Member
108 Filter
110 Amplifier
112 Printed Circuit Board (PCB)
114 Printed Circuit Board (PCB) Mounting Structure
116 Power Source
118 Receiving PCB
120 Mobile Device
122 Receiving Antenna
124 Charging Zone
126 Lighting Element
200 A-Pillar
202 B-Pillar
204 C-Pillar
206 Sun Visor
208 Door Panel
210 Instrument Panel
212 Armrest
214 Seat
216 Headliner
218 Seat Belt Housing
220 Headrest
222 Rear Storage Compartment

1-14. (canceled)

15. A wireless charging system mounted to a vehicle component, comprising:
an assembly attached to the vehicle component, wherein the assembly comprises a printed circuit board (PCB) and at least one transmitting antenna producing a charging zone, with the charging zone emitting power within an area that has a shape approximately equaling a cone; and
a power source connected to the PCB.

16. The wireless charging system of claim 15, wherein the PCB comprises at least one amplifier and at least one filter.

17. The wireless charging system of claim 15, wherein the at least one transmitting antenna is oriented within 0 mm to 25.4 mm from an outer surface of the vehicle component.

18. The wireless charging system of claim 15, wherein at least one of:
the charging zone provides up to 25 watts power to a mobile device,
multiple mobile devices are able to be charged simultaneously within the charging zone, and
multiple charging zones are provided by multiple transmitting antenna.

19. The wireless charging system of claim 15,
wherein the wireless charging system is adapted to charge at least one mobile device comprising a receiving antenna, and
wherein the mobile device is selected from a group consisting of a cell phone, a wearable, a dongle, an actuation element, a lighting element, a heating element, a cooling element a wireless earbud, and a tablet.

20. The wireless charging system of claim 19, wherein the dongle is electrically connected to at least one of an LED, a seat motor, a window motor, a door locking mechanism, or a sensor.

21. The wireless charging system of claim 15, wherein
the vehicle component is comprised at least partly by the wireless charging system, and
the vehicle component is selected from a group consisting of a center console, an A-pillar, a B-pillar, a C-pillar, a sun visor, a door panel, an instrument panel, a an armrest, a seat, a headliner, a seat belt housing, a roof, a headrest, a rear view device, and a rear storage compartment.

22. The wireless charging system of claim 15, wherein the power source is activated at vehicle start or with the activation of a switch.

23. The wireless charging system of claim 15, wherein the at least one transmitting antenna is tubular in shape and/or has a circular or square cross-section containing a cylinder with coiled copper element around the cross-section dimension of the cylinder, wherein the coiled copper element is adapted for power level tuning from milliamps to kilowatts and/or operates at a desired frequency around 6.78 MHz.

24. The wireless charging system of claim 15,
wherein the wireless charging system is incorporated into a textile surface, and
wherein the cylinder portion of the transmitting antenna is woven into the textile surface and attached to the transmitting antenna and the PCB.

25. The wireless charging system of any one of the claim 15, wherein the transmitting antenna is manufactured by over molding in the vehicle component.

26. The wireless charging system of claim 15, wherein the layer assembly comprises
a PCB mounting structure,
the PCB,
a structural member,
the transmitting antenna, and
a cover.

27. A vehicle component with at least one wireless charging system of claim 15.

28. A vehicle with at least one wireless charging system of claim 15.
